(19) United States
(12) Patent Application Publication
(10) Pub. No.: US 2017/0032293 A1
(43) Pub. Date: Feb. 2, 2017

(54) SYSTEM AND METHOD FOR BUSINESS PROCESS MULTIPLE VARIANT VIEW

(71) Applicant: WORKSOFT, INC., DALLAS, TX (US)

(72) Inventor: JIM DUGGER, DALLAS, TX (US)

(21) Appl. No.: 14/815,059

(22) Filed: Jul. 31, 2015

(51) Int. Cl. G06Q 10/06

(52) U.S. Cl. CPC G06Q 10/067; G06Q 10/06316

(57) ABSTRACT

A method for generating a business process diagram that generates a plurality of business variants occurring within a business process. Each of the business variants includes at least one business activity. A first business variant including a most common group of business activities occurring within the plurality of business variants is determined and placed in a first variant lane on a horizontal central axis of the business process diagram. A scoring value is generated for each of the remaining plurality of business variants other than the first business variant. Each of the remaining plurality of business variants are located in a plurality of variant lanes adjacent to the first variant lane and the first variant lane responsive to the scoring values. Wherein at least a portion of the remaining plurality of business variants and the first business variant share business activities in the most common group of business activities within the business process diagram. Starting nodes and ending nodes for the first business variant and the remaining plurality of business variants are placed to avoid crossing lines within the business process diagram.

### TECHNICAL FIELD

The present invention relates to business process modeling diagrams (BPMDs), and more particularly, to the generation of a business process multiple variant view diagram.

### BACKGROUND

Business operations are complex processes comprising a variety of business activities that are combined together in various fashions in order to perform various business processes. The interrelationship of all of these business activities and business processes are often very difficult to analyze and understand with respect to the overall operations of a particular business. Business Process Modeling Notation (BPMN) is one manner for depicting business operations using a graphical representation to specify business processes in a business process model. BPMN is a standard for business process modeling that provides a graphical notation for specifying a business process in a business process diagram using a flowcharting technique. The objective of BPMN is to support business process management for both technical users and business users by providing a notation that has the ability to present information to business users and represent complex process semantics. Traditional BPMN diagrams use swim lanes and activities to indicate all possible flows of a business process. However, these diagrams can become unwieldy and difficult to read when depicting very complex business processes. Thus, there is a need for a method for generating simplified business process modeling diagrams depicting only the specific variations of possible flows interesting to the reader.

### SUMMARY

The present invention, as disclosed and described herein, in one aspect thereof, comprises a method for generating a business process diagram that generates a plurality of business variants occurring within a business process. Each of the business variants includes at least one business activity. A first business variant including a most common group of business activities occurring within the plurality of business variants is determined and placed in a first variant lane on a horizontal central axis of the business process diagram. A scoring value is generated for each of the remaining plurality of business variants other than the first business variant. Each of the remaining plurality of business variants is located in a plurality of variant lanes adjacent to the first variant lane responsive to the scoring values. At least a portion of the remaining plurality of business variants and the first business variant share business activities in the most common group of business activities within the business process diagram. Starting nodes and ending nodes for the first business variant and the remaining plurality of business variants are placed to avoid crossing lines within the business process diagram.

### BRIEF DESCRIPTION OF THE DRAWINGS

For a more complete understanding, reference is now made to the following description taken in conjunction with the accompanying Drawings in which:

FIG. 1 is a flow diagram generally illustrating a process for generating a business process multiple variant view;

FIG. 2 illustrates the various business activities associated with multiple end-to-end business process variants;

FIG. 3 illustrates the business process variant containing the most common business activity elements:

FIG. 4 illustrates the selection of adjacent business processes variants to the initially selected business process variant of FIG. 3;

FIG. 5 illustrates a completed business process multiple variant view;

FIG. 6 is a flow diagram more particularly describing the various phases used in generating the business process multiple variant view of FIG. 5;

FIG. 7 is a flow diagram more particularly describing the process for determining a most constrained activity of the process of FIG. 6;

FIG. 8 is a flow diagram more particularly describing the process for applying activity constraints to the process of FIG. 6;

FIG. 9 is a flow diagram more particularly describing the process for applying variant constraints within the process of FIG. 6;

FIG. 10 is a flow diagram more particularly describing the process for applying link constraints within the process of FIG. 6; and

FIG. 11 is a block diagram illustrating a computer system for implementing the process for generating the business process multiple variant you diagrams.

### DETAILED DESCRIPTION

Referring now to the drawings, wherein like reference numbers are used herein to designate like elements throughout, the various views and embodiments of system and method for business process multiple variant view are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

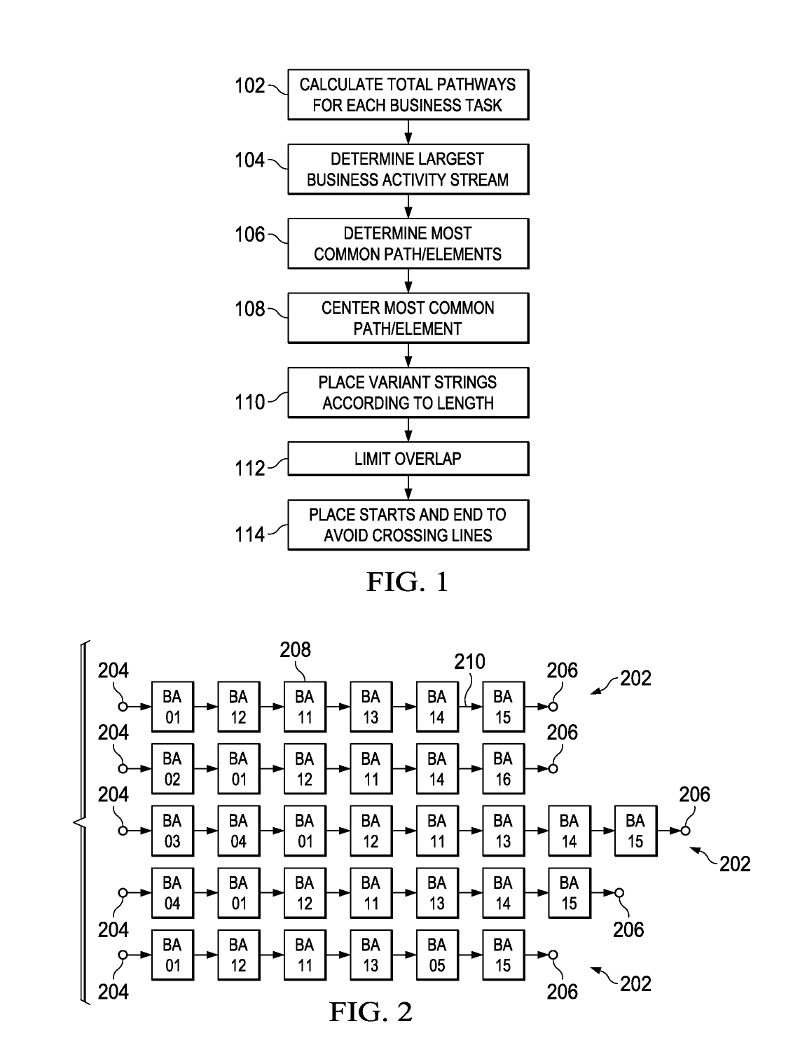

Referring now to the drawings, and more particularly to FIG. 1, there is illustrated a flow diagram of the process for generating a Business Process Multiple Variant View Diagram. First a particular business operation is analyzed to determine the total number of business variants that are within the operation. A business variant is a number of business activities that are performed to take a particular business process from start to finish. Thus, step 102 involves analyzing the business operation to calculate the total number of business variant pathways that are present within the complete business operation. Each variant pathway represents a particular business process from start to finish in the business operation.

This step is more particularly illustrated in FIG. 2 which illustrates five different business variants 202 that are within a particular business operation. Each business variant 202 includes a starting node 204 and an ending node 206. Each of the starting nodes 204 and ending nodes 206 are interconnected via a number of business activities 208. A particular business variant 202 will include one or more business activities 208 that must be performed to pass from the starting node 204 to the ending node 206. The business activities 208 and starting and ending nodes 204, 206 are interconnected via links 210 that illustrate a passing from one business activity 208 or node to the next as a business process is executed.

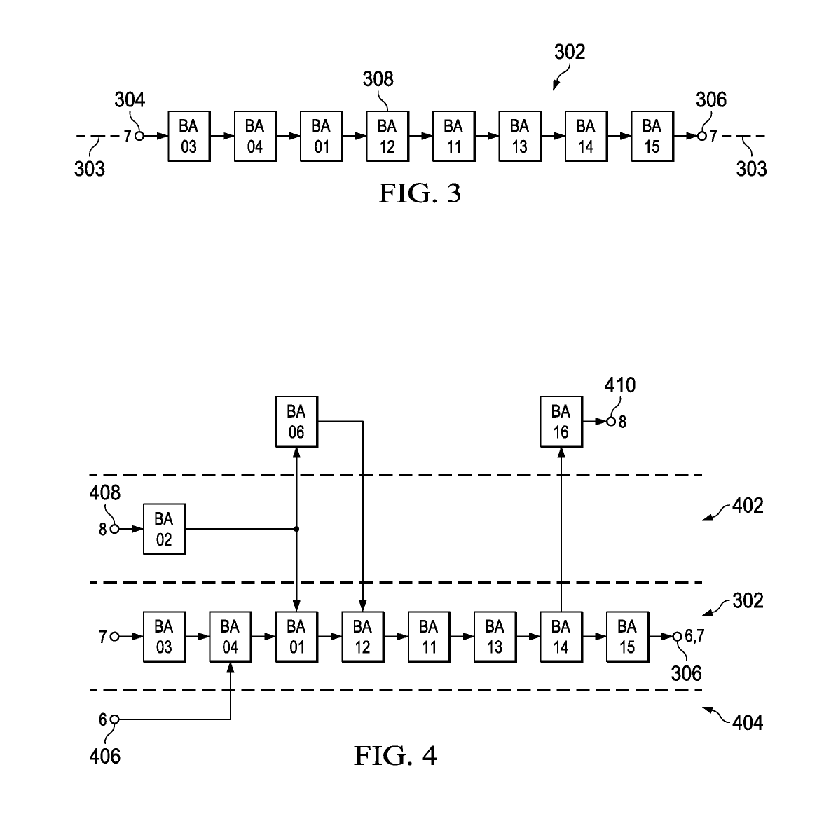

Referring now back to FIG. 1, once the total number of business variant pathways have been determined at step 102, a determination is made at step 104 of the largest business activity stream or streams. Next, at step 106 with respect to the largest business variant streams, a determination is made of the business variant 202 including the greatest number of most common business activity elements 208 between all the business variants 202 of the business operation. The selected business variant 202 including the greatest number of most common elements 208 is placed at the horizontal center axis of the business process multiple variant view at step 108 as illustrated in FIG. 3. As illustrated in FIG. 3, the selected business variant 302 is placed on the horizontal center axis 303 of the diagram. In the present embodiment the business variant is designated variant 7. Variant 7 proceeds from a starting node 304 to the ending node 306. Starting node 304 and ending node 306 are interconnected via a series of business activities 308. These business activities are identified as BA 03, BA 04, BA 01, BA 12, BA 11, BA 13, BA 14, BA 15, respectively. At least a portion of these business activities 308 are most commonly used amongst all of the business variants 302 within the analyzed business operation.

Once the business variant 202 including the most common business activities has been selected and placed on the horizontal center axis 303 of the diagram, the business variants 202 are selected according to factors such as length at step 110 in order to provide a most compact view of the business process multiple variant view diagram. As illustrated in FIG. 4, two additional business variant lanes 402 and 404 are placed immediately adjacent to the business variant 302 that was selected and placed at the horizontal center axis 303 of the diagram as illustrated in FIG. 3. These newly added business variants include a business variant designated 6 and a variant designated as 8. Business variant 6 begins at node 406 and ends at node 306 which is the same node at which variant 7 ends. Business variant 6 provides no new business activities 308 but merely utilizes business activities BA 04, BA 01, BA 12, BA 11, BA 13, BA 14, BA 15 of business variant 302. Business variant 8 begins at node 408 and ends at node 410. Business variant 8 adds business activity BA 02 to the beginning of the business variant and adds business activity BA 16 to the end of the process. Business variant 8 also uses common business activity nodes BA 01, BA 06, BA 12, BA 11, BA 13 and BA 14 from business variant 302. Once each of the business variants 202 have been placed at step 110, adjustments may be made at step 112 to limit overlap between connecting links between business activities 208. The placement of the beginning and ending nodes 204, 206 may be adjusted at step 114 to avoid the crossing of connectors.

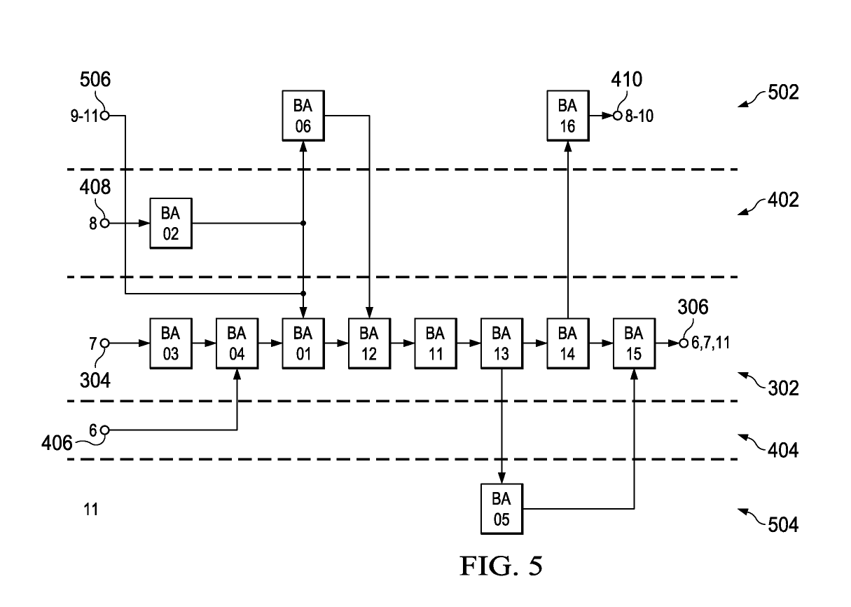

Referring now to FIG. 5, there is illustrated a business process multiple variant view diagram including all of the steps associated with a business process. Additional business variants have been added to the diagram described with respect to FIG. 4. Variant lanes 502 and 504 have been added to the diagram. Business variants 9 through 11 have been added to the diagram. The beginning node for variants 9 through 11 is provided at node 506 of variant lane 502. Business variants 9 and 10 end at previous node 410, while business variant 11 ends at previous node 306. Business variants 9 through 11 are located within variant lane 502. Variants 9-11 intersect the central business variant 302 at business activity node BA 01 and pass through BA 12, BA 11 and BA 13. Business variant 11 next passes to business activity BA 05 in variant lane 504. Business activity BA 05 links with business activity BA 15 and ends at ending node 306. Business variants 9 and 10 pass from business activity BA 13 to BA 14 and to business activity BA 16 in variant lane 502. Variants 9 and 10 are completed at node 410.

There are many correct possible presentations of a multi-variate view. Any presentation which correctly flows through the business process is a valid presentation. However, the goal of the multi-variate view is to provide a diagram in an information dense and compact presentation. The described implementation provides an approach to drawing the visualization that results in the most compact and readable diagrams possible. Diagrams that scroll horizontally are difficult to consume, so the best diagrams are the most compact. By determining where the most and largest common strings of business activities occur across the represented business process, the most compact configuration may be generated. If consolidation is performed correctly, outlier performances of the business process will neatly fit around the most common path when it is centered. Because areas both above and below the diagram are useful, selecting the process flow with the most common elements in the center tends to work well for creating clean diagrams. By organizing for process overlap, diagram readability is improved. Crossing flow lines in a diagram destroys readability. After determining the center business variant, placing business variants with short variant strings near to the center and longer strings further from the center, either above or below the center, is a function of which side provides the most opportunity for consolidation. This results in short variant excursions being contained by longer ones and avoiding the crossing of lines. Finally providing short start node connections and end node connections avoids the crossing of connection lines.

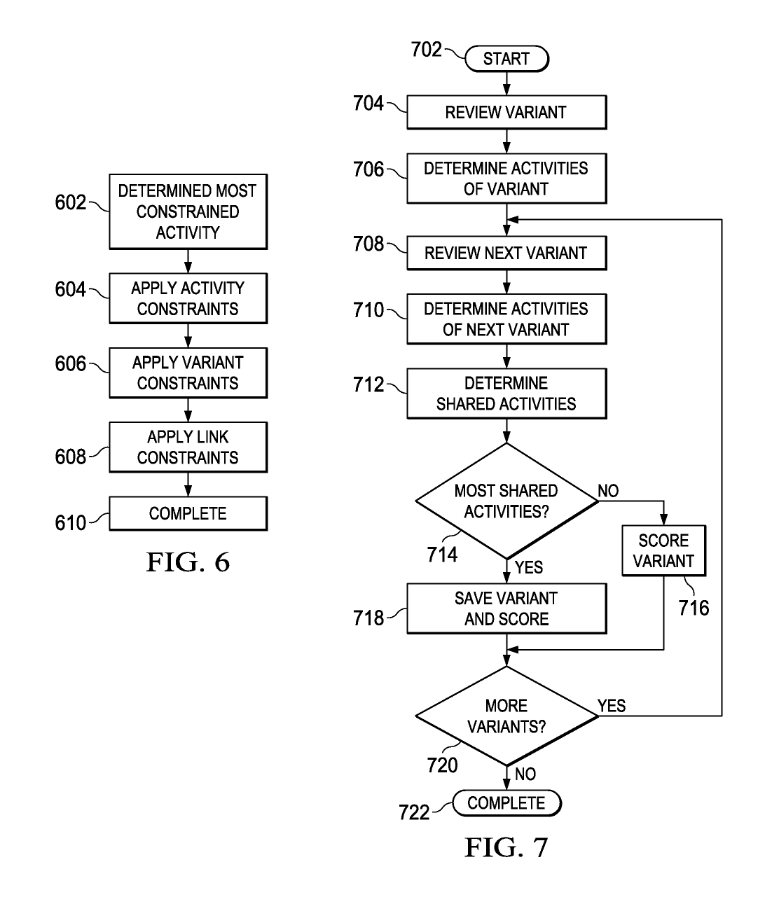

Referring now to FIG. 6, there is more particularly illustrated the process for scoring business variants to be placed within a business process multiple variant view diagram and application and scoring of the constraints associated with placing the business variants within a diagram. Initially, at step 602, a determination of the most constrained activity within the business variants is made. The most constrained activity is the business activity or activities shared among the most business variants. The business variant to be selected is the longest of the business variants that contains this activity or group of activities. The other business variant may then be scored based upon whether or not they contain the constrained activity. Within the next phase of the process, the activity constraints are applied at step 604. Each activity constraint has their own scoring algorithm based upon a weight and a threshold. The activity constraints include loop constraints, backward link constraints, activity collision constraints, vertical length constraints, and horizontal length constraints. The loop constraint, backward link constraints and activity collision constraints are hard constraints and identify whether or not that situation occurs. These constraints have a higher weighted value since they are hard constraints. The vertical length constraint and horizontal length constraints are scored based upon whether the vertical or horizontal distance violate some predetermined threshold. A constraint is resolved and re-scored an iterative number of times or for some predetermined time limit. Within each activity constraint, the scoring function also recommends the resolution of an issue which may be a row to try, row/column to try, stacking or cloning activity.

Next, the variant constraints are applied at step 606, and the various business activities are scored based upon variant placements. After activity constraints have been applied, variant placement may be scored to identify opportunities for improvements to the diagram. In some cases a row may only contain a single activity because the sharing of activities across variants and moving a variant may make sense. In another case, there may be no activities within a variant row so that the row may be collapsed and removed. The variant constraints are scored based upon the distance of their connections and a threshold. If the variant constraints cause movement of a row, and time permits, the constraints may be re-applied, but this is not required because the variant constraints are only looking for an opportunity to improve the overall solution of the diagram.

At step 608 the link constraints are applied, the initial links between business activities are only constrained by not allowing a link to pass through a business activity. When link constraints are applied, the activity links are scored based upon the number of overlapping lines, intersecting lines and connector issues for each path. This step requires the most time and searching because determining the path directly impacts the search time. Thus, a more tightly constrained search base may be initially used and expanded if needed. The links from the start nodes are also determined at this phase which can cause intersecting or overlapping lines, so link constraints are applied to these also. As nodes are created, a best fit in the link constraints are applied also to the nodes. Once each of these phases have been carried out, the business variants may be placed upon the diagram in accordance with the scoring and the diagram completed at step 610.

Referring now to FIG. 7, there is more particularly illustrated the steps associated with the process of determining the most constrained activity. The process is initiated at step 702 and a first business variant is reviewed at step 704. The number of activities contained within the reviewed business variant is determined at step 706. After the first business variant and associated business activities have been reviewed, the next business variant is reviewed at step 708. The business activities associated with this business variant are determined at step 710. Step 712 determines if there exist any shared business activities between the reviewed business variants. Inquiry step 714 determines whether the most recently compared business variant has the most shared business activities, and if not, the variant is scored at step 716. If inquiry step 714 determines that the most recently compared business variant does share the most business activities, the business variant is saved as the new high variant score and the business variant is scored at step 718. After the most recently compared business variant has been scored at step 716 or scored and saved as the new high activity variant at step 718, inquiry step 720 determines whether more business variants are available. If so, control passes back to step 708 to review the next business variant and compare this business variant to the present high score variant. If no further business variants exist at inquiry step 720, the process is completed at step 722 and the most recently saved high shared activity business variant may be placed upon the diagram.

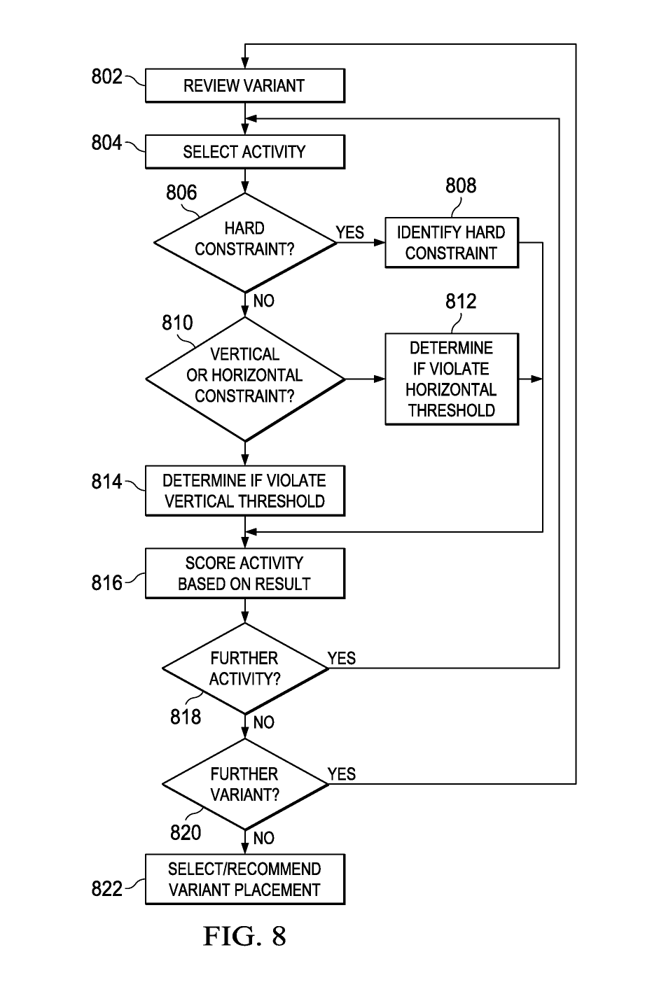

Referring now to FIG. 8 there is more particularly illustrated the process for applying the activity constraints at step 606 of FIG. 6. An initial business variant is reviewed at step 802. An activity within the business variant is selected at step 804. Inquiry step 806 determines if the activity has a hard constraint associated therewith. If inquiry step determines that the activity has a hard constraint associated therewith, the particular type of hard constraint is identified at step 808. If no hard constraints are associated with the selected business activity at step 806, inquiry step 810 determines whether there is a vertical or horizontal constraint associated with the business activity. If a horizontal constraint is associated therewith, control passes to step 812 and a determination is made if the activity violates the horizontal threshold. If inquiry step 810 determines that a vertical constraint is associated with the business activity, step 814 determines if the vertical threshold has been violated. Once the selected business activity has been identified as a hard constraint, vertical or horizontal constraint, the activity is scored at step 816 based upon this determination.

Inquiry step 818 determines if there are further activities within the business variant being processed. If so, control passes back to step 804 and a next activity is selected for scoring and analysis. If no further business activities are within the business variant, control passes to inquiry step 820 to determine if further business variants exist for analysis. If further business variants exist, control passes back to step 802 and the next business variant is reviewed. If no further business variants are available, control passes to step 822 wherein the business variants are selected/recommended for placement within the diagram based upon the scoring of the activity constraints within the various business variants.

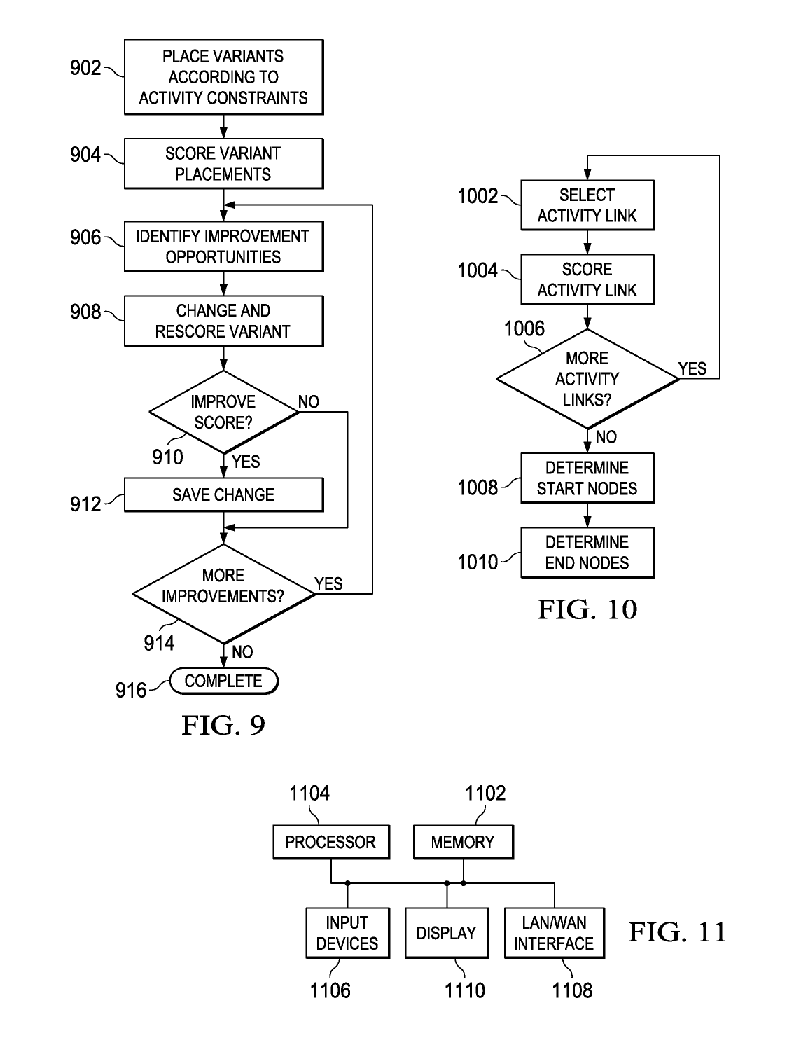

Referring now to FIG. 9, there is more particularly illustrated the process for applying the variant constraints in step 606 of FIG. 6. The business variants are initially placed at step 902 based upon the previously determined activity constraints of FIG. 8. The business variant placements are scored at step 904 based upon the initial placements. Improvement opportunities within the business variant placements are determined at inquiry step 906. Improvement determinations are made by evaluating the resulting diagram using the scoring algorithm. The scoring algorithm looks for layout compactness, crossing lines, and other exceptions on the solution as a whole. Changes may then be made to the business variant placement based upon these improvement determinations and the variant rescored at step 908. Inquiry step 910 determines if the movement and rescoring have improved the score. If the scores improve, the change is saved at step 912. After the saved changes or if the score is not improved, control passes to inquiry step 914 to determine if additional improvements exist. If so, control passes back to step 906 to identify the additional improvement and the improvement is used to change and rescore the business variant as previously described. When no further improvement opportunities exist the process is completed at step 916.

Referring now to FIG. 10, there is illustrated the process for applying the link constraints of step 608 of FIG. 6. A variant a particular activity link is selected at step 1002. The activity link is scored at step 1004 based upon the ability of the link to cleanly exit one business activity and connect with another. This is done base on the fewest number of crossing lines and generally left-to right flowing order. The algorithm must determine which of the common exit nodes (top, right, bottom) may be used ideally to achieve diagram goals, but also take into account ones already used for activity flow inputs. Inquiry step 1006 determines if additional activity links exist. If additional activity links exist, the links are selected at step 1002 and scored at step 1004. If no further activity links exist, control passes to step 1008 which determines placement of the start nodes. Finally, at step 1010, the end nodes are determined and placed.

Referring now to FIG. 11, there is illustrated a block diagram of a computer system for implementing the process for generating the business process multiple variant view diagrams described herein above. A memory 1102 may store instructions for performing the various steps of the diagram generation process described herein. These instructions within the memory 1102 would control the operations of a processor 1104. The processor 1104 would receive input parameters for generation of the diagram from associated input devices 1106 and from a local or wide area network via a LAN/WAN interface 1108. The diagrams may be output from the processor 1104 to a display 1110 or some other type of printing or plotting device.

Relying upon the above scoring in a business variant analysis process, a best available estimate may be made of placement of each of the business variants within a particular business process multiple variant view diagram. In this manner, the diagram can be generated to provide a most compact and readily understandable view of a particular business process in a manner that will aid individuals in analysis of the business process operations.

It will be appreciated by those skilled in the art having the benefit of this disclosure that this system and process for business process multiple variant view provides an improved manner for the generation of business process diagrams more easily read and utilize by individuals analyzing operations of a business. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A method for generating a business process diagram, comprising:
generating plurality of business variants occurring within a business process, each of the business variants including at least one business activity;
determining a first business variant including a most common group of business activities occurring within the plurality of business variants;
placing the first business variant in a first variant lane on a horizontal central axis of the business process diagram;
generating a scoring value for each of the remaining plurality of business variants other than the first business variant;
locating each of the remaining plurality of business variants in a plurality of variant lanes adjacent to the first variant lane responsive to the scoring values, wherein at least a portion of the remaining plurality of business variants and the first business variant share business activities in the most common group of business activities within the first variant lane of the business process diagram; and
placing starting nodes and ending nodes for the first business variant and the remaining plurality of business variants to avoid crossing lines within the business process diagram.

2. The method of claim 1 further including the step of locating each of the remaining plurality of business variants in the plurality of variants lanes and the first variant lane to limit overlap between connecting lines of the business variants.

3. The method of claim 1, wherein the step of generating the scoring value further comprises generating the scoring value responsive to activity constraints associated with each of the business activities within the plurality of business variants.

4. The method of claim 3, wherein the step of generating the scoring value responsive to the activity constraints further comprises:
determining whether a business activity comprises a hard constraint, a horizontal constraint or a vertical constraint;
scoring the business activity responsive to a determination that the business activity comprises a hard constraint;
if the business activity comprises a horizontal constraint,
determining if the business activity exceeds a horizontal constraint threshold;
scoring the business activity based upon whether or not the business activity exceeds the horizontal constraint threshold;
if the business activity comprises a vertical constraint,
determining if the business activity exceeds a vertical constraint threshold; and
scoring the business activity based upon whether or not the business activity exceeds the vertical constraint threshold.

5. The method of claim 1, wherein the step of generating the scoring values further comprises generating the scoring value responsive to variant constraints associated with each of the plurality of business variants.

6. The method of claim 5, wherein the step of generating the scoring values responsive to the variant constraints further comprises:
locating the business variants in a first configuration according to an initial determination within the business process diagram;
scoring the business process diagram according to first configuration of the business process diagram;
identifying improvements to placement of business variants within the business process diagram;
locating business variants in a second configuration according the improvements of the placement of the business variants within the business process diagram;
scoring the business process diagram according to the second configuration of the business process diagram; and
selecting the first configuration or the second configuration of the business process diagram based on the scoring.

7. The method of claim 1, wherein the step of generating the scoring value further comprises generating the scoring value responsive to link constraints associated with each of the business activities within the plurality of business variants.

8. The method of claim 7, wherein the step of generating the scoring value responsive to the link constraints further comprises:
selecting each of the activity links within a business variant;
generating a score for each of the activity links within the business variant; and
generating a scoring value for the business variant responsive to the score for each of the activity links.

9. A method for generating a business process diagram, comprising:
generating plurality of business variants occurring within a business process, each of the business variants including at least one business activity;
determining a most constrained group of business activities within the plurality of business variants;
scoring each of the plurality of business variants responsive to business activity constraints within each of the plurality of business variants;
scoring each of the plurality of business variants responsive to variant constraints associated with each of the plurality of business variants;
scoring each of the plurality of business variants responsive to link constraints associated with links within each of the plurality of business variants;
generating a combined score for each of the plurality of business variants responsive to the scores based on activity constraints, variant constraints and link constraints; and
generating the business process diagram responsive to the combined score for each of the plurality of business variants and the determined most constrained group of business activities.

10. The method of claim 9, wherein the step of generating the scoring value responsive to the activity constraints further comprises:
determining whether a business activity comprises a hard constraint, a horizontal constraint or a vertical constraint;
scoring the business activity responsive to a determination that the business activity comprises a hard constraint;
if the business activity comprises a horizontal constraint,
determining if the business activity exceeds a horizontal constraint threshold;
scoring the business activity based upon whether or not the business activity exceeds the horizontal constraint threshold;
if the business activity comprises a vertical constraint,
determining if the business activity exceeds a vertical constraint threshold; and
scoring the business activity based upon whether or not the business activity exceeds the vertical constraint threshold.

11. The method of claim 9, wherein the step of generating the scoring values responsive to the variant constraints further comprises:
locating the business variants in a first configuration according to an initial determination within the business process diagram;
scoring the business process diagram according to first configuration of the business process diagram;
identifying improvements to placement of business variants within the business process diagram;
locating business variants in a second configuration according the improvements of the placement of the business variants within the business process diagram;
scoring the business process diagram according to the second configuration of the business process diagram; and
selecting the first configuration or the second configuration of the business process diagram based on the scoring.

12. The method of claim 9, wherein the step of generating the scoring value responsive to the link constraints further comprises:
selecting each of the activity links within a business variant;
generating a score for each of the activity links within the business variant; and
generating a scoring value for the business variant responsive to the score for each of the activity links.

13. The method of claim 9 further comprising the step of placing a first business variant in a first variant lane on a horizontal central axis of the business process diagram responsive to the most constrained group of business activities within the plurality of business variants.

14. The method of claim 13 further including the step of locating each of the remaining plurality of business variants in a plurality of variants lanes and the first variant lane to limit overlap between connecting lines of the business variants.

15. A method for generating a business process diagram, comprising:
generating plurality of business variants occurring within a business process, each of the business variants including at least one business activity;
determining a most constrained group of business activities within the plurality of business variants;
generating a combined score for each of the plurality of business variants responsive to at least one constraint associated with the business variant;
placing a first business variant in a first variant lane on a horizontal central axis of the business process diagram responsive to the most constrained group of business activities within the plurality of business variants;
locating each of the remaining plurality of business variants in a plurality of variant lanes adjacent to the first variant lane and the first variant lane responsive to the combined score, wherein at least a portion of the remaining plurality of business variants and the first business variant share business activities in the most common group of business activities within the business process diagram; and
generating the business process diagram responsive to the placement of the first business variant and the located remaining plurality of business variants.

16. The method of claim 15, wherein the step of generating a combined score further comprises:
scoring each of the plurality of business variants responsive to business activity constraints within each of the plurality of business variants;
scoring each of the plurality of business variants responsive to variant constraints associated with each of the plurality of business variants;
scoring each of the plurality of business variants responsive to link constraints associated with links within each of the plurality of business variants; and
generating a combined score for each of the plurality of business variants responsive to the scores based on activity constraints, variant constraints and link constraints.

17. The method of claim 16, wherein the step of generating the scoring value responsive to the activity constraints further comprises:
determining whether a business activity comprises a hard constraint, a horizontal constraint or a vertical constraint;
scoring the business activity responsive to a determination that the business activity comprises a hard constraint;
if the business activity comprises a horizontal constraint,
determining if the business activity exceeds a horizontal constraint threshold;
scoring the business activity based upon whether or not the business activity exceeds the horizontal constraint threshold;
if the business activity comprises a vertical constraint,
determining if the business activity exceeds a vertical constraint threshold; and
scoring the business activity based upon whether or not the business activity exceeds the vertical constraint threshold.

18. The method of claim 16, wherein the step of generating the scoring values responsive to the variant constraints further comprises:
locating the business variants in a first configuration according to an initial determination within the business process diagram;
scoring the business process diagram according to first configuration of the business process diagram;
identifying improvements to placement of business variants within the business process diagram;
locating business variants in a second configuration according the improvements of the placement of the business variants within the business process diagram;
scoring the business process diagram according to the second configuration of the business process diagram; and
selecting the first configuration or the second configuration of the business process diagram based on the scoring.

19. The method of claim 16, wherein the step of generating the scoring value responsive to the link constraints further comprises:
selecting each of the activity links within a business variant;
generating a score for each of the activity links within the business variant; and
generating a scoring value for the business variant responsive to the score for each of the activity links.

20. The method of claim 15 further including the step of locating each of the remaining plurality of business variants in a plurality of variants lanes and the first variant lane to limit overlap between connecting lines of the business variants.
